(19) United States
(12) Patent Application Publication
(10) Pub. No.: US 2016/0220330 A1
(43) Pub. Date: Aug. 4, 2016

(54) METHOD FOR USING DIGITAL BRACKET LOCATION DATA FOR AUTOMATED JIG REMANUFACTURING

(71) Applicant: Marc S. Lemchen, New York, NY (US)

(72) Inventor: Marc S. Lemchen, New York, NY (US)

(21) Appl. No.: 14/612,165

(22) Filed: Feb. 2, 2015

(51) Int. Cl. A61C 7/14; A61C 7/00

(52) U.S. Cl. CPC A61C 7/146; A61C 7/002; A61C 2204/005; A61C 2007/004

(57) ABSTRACT

A method of remanufacturing a jig for an orthodontic bracket corresponding to a tooth includes the steps of scanning recorded bracket tooth shape, bracket type and location data from a radio frequency identification (RFID) microchip in or on the bracket for the tooth at a treatment site. The RFID microchip has recorded therein bracket tooth shape, bracket type and location data of the intended precise position of the bracket on the corresponding tooth, or in the absence of the RFID microchip downloading the tooth shape, bracket type and location data for the tooth from a computer database. The tooth shape, bracket type and location data is provided to a three dimensional printer. A jig is manufactured at the treatment site using the three dimensional printer to provide a jig which precisely fits the tooth and which carries the correct type bracket for precise placement onto the tooth.

### BACKGROUND

1. Field of the Technology

The invention relates to the field of orthodontic brackets, in particular the location data, identification, tracking, and status of the brackets as used in a patient's mouth during orthodontic treatment for automatic remanufacturing of an orthodontic jig.

2. Description of the Prior Art

Orthodontic brackets have long been in used in the orthodontic field to assist in the treatment of a variety of cosmetic and structural teeth and jaw problems such as crooked teeth, overbite, and other malocclusions. Typically, an orthodontist assesses the teeth of a patient and determines what prescription of brackets are required for that particular patient's specific needs. Each bracket prescription comprises a plurality of specific pre-selected features such as torque and tip varieties that are machined into the bracket slot. Once fabricated, each bracket is cemented to the patient's teeth with extra attention and consideration given to make sure each bracket is in fact cemented to the tooth for which it was intended. If the bracket becomes broken or if the prescription becomes outdated, a replacement bracket is manufactured, the old bracket is removed, and then the new bracket is inserted into its place. The problem is how to accomplish this task.

The placement of the brackets begins with a specification of the location of the bracket on each tooth. This specification is unique for each patient. The conventional practice is to precisely place orthodontic brackets on a tooth or teeth by constructing a virtual model of the patient's actual teeth in the perfect positions, placing the brackets on this virtual perfect model and then carrying these positions to the patient's mouth in a precision tray or jig to position the brackets on the patient's teeth in the exact positions that the brackets had in the virtual or in some cases in a real plaster or three dimensionally printed model.

A problem then arises when a patient has a bracket that has become disconnected from the tooth or lost. It is imperative that the bracket be replaced or repositioned in the exact original or perfect position on that individual's tooth for the orthodontic wires to operatively position that tooth as originally intended. The conventional practice required that the original jig had to be available, usually stored in the office, for that individual and that individual tooth. Storing a jig for each patient for a large number of patients requires a commensurate amount of storage space, cataloging, and retrieval systems to find and produce the original jig when needed. This aspect of the orthodontic practice is time consuming and space intensive leading to high overheads and service burdens. In lieu of such an inventory of original jigs, a new jig and bracket could be ordered from the lab or dental company that did the initial set up, but this too requires time and added expense.

We had developed an apparatus and method that allows orthodontists and other dental professionals to quickly determine the bracket type present on a patient's tooth and ensure that if any replacement brackets are required, the proper bracket will be installed without error as disclosed in U.S. Pat. No. 8,235,716, incorporated herein by reference. This method used a radio frequency identification (RFID) microchip in an orthodontic bracket, where the RFID chip has recorded thereon information concerning the nature of the bracket, which could then be read or scanned and so that the bracket would be used according to its type as scanned from the corresponding RFID chip. This included using the information for determining an inventory of the brackets on hand and confirming correct handling.

However, this system and method had no provision or capability of reproducing an orthodontic tray or jig for a patient. Furthermore, since a bracket was replaced using an original saved jig, the location of placement was typically not numerically recorded.

Before describing the illustrated embodiments of the invention, it must be first made clear why the precise position on a tooth of its bracket must be determined and reestablished in the case of a bracket reaffixation or replacement. To provide for braces for a patient an actual or virtual three dimensional copy of the patient's teeth are made with by taking an impression, making a physical mold and then a model of the teeth or by optically scanning the surfaces of the teeth. In either case, an accurate record is made of the three dimensional shape of each tooth. The orthodontist then makes an actual or virtual model on a computer of an ideal or desired occlusion (bite, relationship of teeth to one another, adjacent and opposing) and alignment. Again this is either done by taking the teeth from the physical model and configuring an ideal alignment or bite, or taking the optically scanned images of the teeth and making an ideal alignment or bite in a computer model. The orthodontist then places the brackets physically or virtually on the ideal model such that the resilient wire or wires used in the braces run straight through the slots on each bracket with no or only a minimal force being applied to the bracket and hence tooth. Thus, when the brackets, attached to their designated positions on the teeth, are aligned in an ideal manner, the wire will be straight and there will be no or minimal forces applied to the teeth. Any alignment departing from the ideal alignment will bend the wire and hence apply a force to the tooth. The tooth will slowly move in the jaw bone to a position where the force on the tooth is minimized.

First, placement on the brackets can be done directly into the patient's mouth onto the determined position for ideal occlusion, each bracket positioned and the bonding agent set by the practitioner. Such a system using virtual pattern recognition of tooth position has been developed by Cadent, Carlstadt, N.J., as the OrthoCAD Bracket Placement System, which however was found to be clinically unsuitable. Second, placement could also be performed by the practitioner on model of the patient's teeth in their original occlusion or on a model, virtual or plaster (stone). In the case of the model representing the original occlusion, a tray in one or multiple pieces is made to transfer the brackets from the model to the patient's mouth. Third, if the brackets are positioned on an ideal model of the ideal occlusion and alignment, an individual transfer tray, or jig, must be used for each tooth.

Thus, when the brackets are placed in their designated position on each tooth in the patient's untreated and misaligned bite, the wire run between the brackets will be bent in a shape and to a degree determined by the degree of misalignment from the ideal. Over time, the resilient wire will tend to straighten, moving each tooth to its ideal position and alignment. However, in order for the ideal alignment and bite to be realized as the wire slowly relaxes, the brackets must remain in their designated positions on each tooth as determined by the orthodontist at the time of determining the ideal alignment or bite. If a bracket loosens, falls off or is lost, it or its replacement must be reaffixed to the tooth at precisely the same designated position on the tooth as determined by the orthodontist at the time of determining the ideal occlusion. If an error in repositioning the bracket is made, the tooth will not move to its ideal position or alignment, but to one which is out of place or out of alignment. As a result, the treating office maintain the original trays or jigs for each of perhaps thousands of patients. Also, a bracket of the exact same design or prescription must be used. If the office does not have the jig as needed, a new one must be ordered from the laboratory.

### BRIEF SUMMARY

As discussed above reuse of original jigs or trays is the conventional method of replacing a detached, broken or lost bracket in an orthodontic setting in a patient. Although location on the tooth for each bracket is not typically measured and saved, even if the location data is measured in some way and recorded, such as downloaded data in a patients chart or from a cloud database, the use of an orthodontic tray or adjustable jig of some kind is still necessary to make precision placements of the replacement bracket.

Therefore, what is disclosed is a process to either three dimensionally print on site a new jig or use of an adjustable jig using precise positioning data stored in an RFID chip as disclosed in U.S. Pat. No. 8,235,716 (incorporated herein), or RFID data previously downloaded from that bracket in the practitioner's office. The practitioner accesses the information and three dimensionally prints a new jig, inserts a similar bracket (stock brackets) into the jig and uses the jig to accurately replace the bracket onto the tooth.

The location of the bracket on each tooth is loaded into the RFID device attached to each bracket when the original bracket placement on each tooth is scanned by the doctor and/or the location data stored in the patient's chart. If the bracket is later dislodged or broken, the location data is readily available by readout from the RFID device attached to the bracket. In case of a patient who has lost the bracket along with its RFID device, the location data would need to be retrieved from a patient database or chart.

More particularly the illustrated embodiments of the invention include a method of remanufacturing a jig for an orthodontic bracket corresponding to a tooth comprising the steps of scanning recorded bracket tooth shape, bracket type and location data from a radio frequency identification (RFID) microchip in or on the bracket for the tooth at a treatment site. The RFID microchip has recorded therein bracket tooth shape, bracket type and location data of the intended precise position of the bracket on the corresponding tooth, or in the absence of the RFID microchip downloading the tooth shape, bracket type and location data for the tooth from a computer database. The tooth shape, bracket type and location data is provided to a three dimensional printer and a jig is manufactured at the treatment site using the three dimensional printer to provide a jig which precisely fits the tooth and which carries the correct type bracket for precise placement of the bracket onto the tooth.

The method further includes the step of simultaneously manufacturing the bracket with the jig with the bracket in place in the jig.

Where the bracket is not manufactured on site, the method further includes using the tooth shape, bracket type and location data to select the bracket from an inventory of brackets.

The method further includes replacing the orthodontic bracket when a change in prescription is needed including the steps of scanning the orthodontic bracket being replaced prior to removal, replacing a current set of patient information with an updated set of scanned information, and documenting in a patient tooth chart correlated to the updated set of scanned information a reason the at least one orthodontic bracket is being replaced.

The method further includes scanning a replacement bracket to insure that the replacement bracket has a proper prescription.

The step of scanning recorded bracket tooth shape, bracket type and location data from the RFID microchip coupled to the bracket further includes the steps of sending the bracket type data to a robotic system. The robotic system selects a bracket based on the bracket type data. The robotic system scans the selected bracket. The robotic system confirms that the selected bracket has the bracket type data. The robotic system records that the selected bracket has been confirmed with having the bracket type data. The robotic system provides the tooth shape, and location data to a three dimensional printer so that the jig is manufactured at the treatment site using the three dimensional printer to provide a jig which precisely fits the tooth and which carries the correct type bracket for precise placement of the bracket onto the tooth. The robotic system sets the selected bracket into the remanufactured jig.

The illustrated embodiments of the invention also include a method of using radio frequency identification (RFID) microchips in orthodontic brackets including the steps of providing a plurality of RFID microchips coupled to, on or in a corresponding plurality of orthodontic brackets, at least one RFID microchip for each tooth, where the plurality of RFID chips have recorded therein information concerning a set of features of each one of the corresponding ones of the plurality of orthodontic brackets, scanning the recorded information from the plurality of RFID chips coupled to the plurality of orthodontic brackets, and employing the plurality of orthodontic brackets according to the recorded information scanned out of the corresponding plurality of RFID chips by using the plurality of RFID chips to give scanned information to a software program which uses the scanned recorded information to manufacture at the treatment site a jig for carrying the brackets or at least one bracket.

The method further includes using the scanned recorded information to manufacture at the treatment site a jig for carrying the brackets or at least one bracket, and to simultaneously manufacture at the treatment site the brackets or at least one bracket.

The method further includes employing the plurality of orthodontic brackets according to the recorded information scanned out of the corresponding plurality of RFID chips by using the plurality of RFID chips to give scanned information to a software program which uses the scanned recorded information to bend custom wires or plan treatment with specialized orthodontic programs.

The step of employing the plurality of orthodontic brackets according to the recorded information scanned from the corresponding plurality of RFID chips includes the step of using the information for determining an inventory of the plurality of orthodontic brackets.

The step of employing the plurality of orthodontic brackets according to the recorded information scanned from the corresponding plurality of RFID chips includes the step of identifying a type for each of the plurality of orthodontic brackets to a user.

The step of identifying the types for each of the plurality of orthodontic brackets to the user includes the step of identifying a prescription of the corresponding plurality of orthodontic brackets including but not limited to at least one torque applied to the plurality of orthodontic brackets or at least one tip machined into a bracket slot for each corresponding tooth.

The step of employing the plurality of orthodontic brackets according to the recorded information scanned from the corresponding plurality of RFID chip includes the steps of identifying the plurality of orthodontic brackets in an area of the mouth, or identifying the plurality of orthodontic brackets in the entire mouth in order to produce a patient tooth chart of a location, prescription, including wire slot size, tip structure, torque applied to the bracket, and/or material of manufacture of each of the plurality of orthodontic brackets.

The method further includes replacing a plurality of orthodontic brackets when a change in prescription is needed including the steps of scanning the plurality of orthodontic brackets being replaced prior to removal, replacing a set of current patient information with an updated set of scanned information, and documenting a reason the plurality of orthodontic brackets are being replaced in a patient tooth chart correlated to the scanned recorded identification.

The method further includes the step of scanning a plurality of replacement brackets to insure that the plurality of replacement brackets have a proper corresponding prescription.

The step of identifying the plurality of orthodontic brackets in an area of the mouth or identifying the plurality of orthodontic brackets in the entire mouth further comprises integrating the identification of the plurality of orthodontic brackets with a practice management program and attaching the practice management program to a patient tooth chart.

The scope of the illustrated embodiments include an apparatus comprising a radio frequency identification (RFID) microchip, and an orthodontic bracket. The RFID microchip is coupled to, in or on the orthodontic bracket, and has recorded thereon information concerning tooth shape, bracket type and location data of the orthodontic bracket. A scanner scans the recorded information from the RFID microchip coupled to the orthodontic bracket. A three dimensional printer communicated to the scanner receives the recorded information to manufacture on site a jig for use in indirect bonding of the bracket to the tooth.

The scope of the illustrated embodiments include an apparatus comprising a computer for storing information concerning tooth shape, bracket type and location data of an orthodontic bracket and a three dimensional printer communicated to the computer for receiving the recorded information to manufacture on site a jig and/or bracket for use in indirect bonding of the bracket to the tooth.

In one embodiment the three dimensional printer communicated to the computer simultaneously manufactures on site a jig and the bracket in the jig for use in indirect bonding of the bracket to the tooth.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is side planar view of the RFID bracket with the RFID microchip coupled to the bottom of the bracket.

FIG. 2 is side cross-sectional planar view of the RFID bracket with the RFID microchip coupled to the bottom of the bracket.

FIG. 3 is a perspective view of the RFID bracket with the RFID microchip coupled to the top of the bracket.

FIG. 4 is a planar cross-section planar view of the RFID bracket with the RFID microchip coupled to the top of the bracket and a planar cross-sectional view of the RFID bracket with the RFID microchip coupled to the lip of the bracket.

FIG. 5 is a block diagram of the procedure taken by the RFID bracket system when an RFID microchip is being scanned.

FIG. 6 is a block diagram of the procedure taken by the RFID bracket system when a broken or outdated RFID microchip is being replaced and a new jig is manufactured for it.

FIG. 7 is a block diagram of the procedure taken by the RFID bracket system when used in a robotic system of bracket placement of FIG. 6.

FIG. 8 is a block diagram of the procedure taken by the RFID bracket system when used in conjunction with a bracket holder.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

The illustrated embodiments of the invention include an apparatus and method for remanufacturing an orthodontic tray or jig to precisely position a replacement bracket or reaffix the original bracket on a patient's tooth after the original bracket has been loosened, dislodged, damaged or lost. In the preferred embodiment a radio frequency identification (RFID) microchip is coupled to, on or in the orthodontic bracket. The designated location or position of the bracket on the corresponding tooth and type of the bracket is stored in each corresponding RFID and/or digital patient record. This allows the practitioner to select the correct corresponding bracket needed for replacement or additional missing bracket needed to be drawn from an inventory, and to reposition the original bracket or replacement bracket, if provided, precisely on the intended position of the tooth by remaking and using a new jig for the dislodged, broken or missing bracket. The new jig for the bracket in question is manufactured by three-dimensional printing at the treatment site using the data read from the RFID for the tooth or the patient's digital record.

In the illustrated embodiment, the practitioner can not only the jig, but the bracket as well, even if the bracket is not of the same material as the original bracket, but in the same prescription. Three dimensional printing also allows both the jig and bracket to be printed at the same time with the bracket already perfectly placed in the precision jig, thereby eliminating any placement error of the bracket in the jig. One or more brackets may thus be printed, including the printing of an entire set of brackets in a tray to place in the patient's mouth.

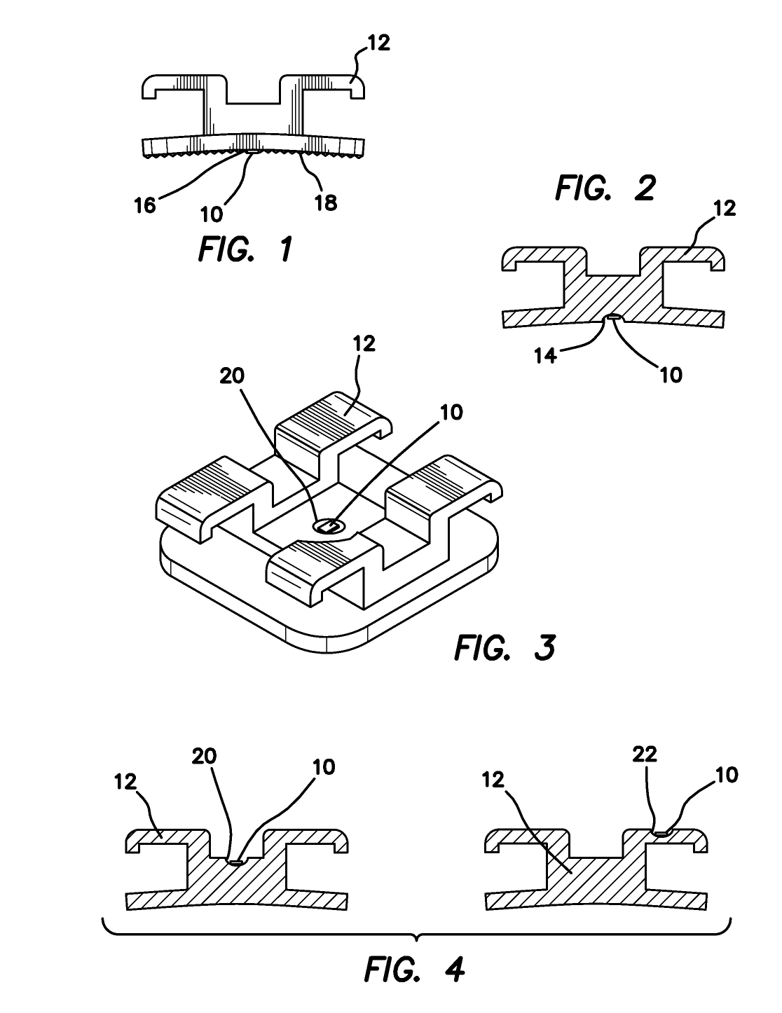

Attachment of an RFID microchip 10 to a metal, ceramic or hard plastic resin bracket 12 is illustrated in FIGS. 1-4. It is to be expressly understood that the resin bracket 12 may be either the ligated or self-ligated type or any other type of bracket now known or later devised. The RFID microchip 10 may be placed in a depression 14 on the tooth side base of the bracket 12 as shown in FIG. 2, which is a “hole” 16 in a mesh backing 18 of the metal bracket 10 as seen in FIG. 1, or adhered to the lip side 22 of the bracket 10 or in a depression or cup 20 and sealed over with a resin sealant as shown in plan view in FIG. 3 or cross-sectional view in FIG. 4.

The advantage of the lip side shown in FIG. 3 is that the RFID microchip 10 is not shielded by the tooth (not shown) or the bracket 12 and can transmit without interference when activated. Also, placement of the RFID chip would be less likely to have any potential effect on the tooth.

In another embodiment, a plurality of brackets 12 may be coupled to a plurality of teeth, each bracket 12 including a corresponding RFID microchip 10 and thus forming a network of brackets.

Each RFID microchip 10 has the ability to store bracket location and type data for each tooth. The bracket location can be generated using a photo scanner of the bracket on the tooth with the photo data reduced to store coordinate positions indexed to the center or other indicia of the bracket and its relative angular orientation on the tooth. Stored type features include but are not limited to the tip, torque, and slot dimensions of the bracket and might include additional information such as the manufacturer and material of manufacture. A complete complement of braces could include brackets 12 of different prescriptions, including location, being placed on each tooth, the prescriptions varying even for the same tooth with each bracket 12 on each opposing side of the tooth varying from one another. The relative location data, identity or information related to each bracket 12 is coded into a unique number stored on each corresponding RFID chip 10.

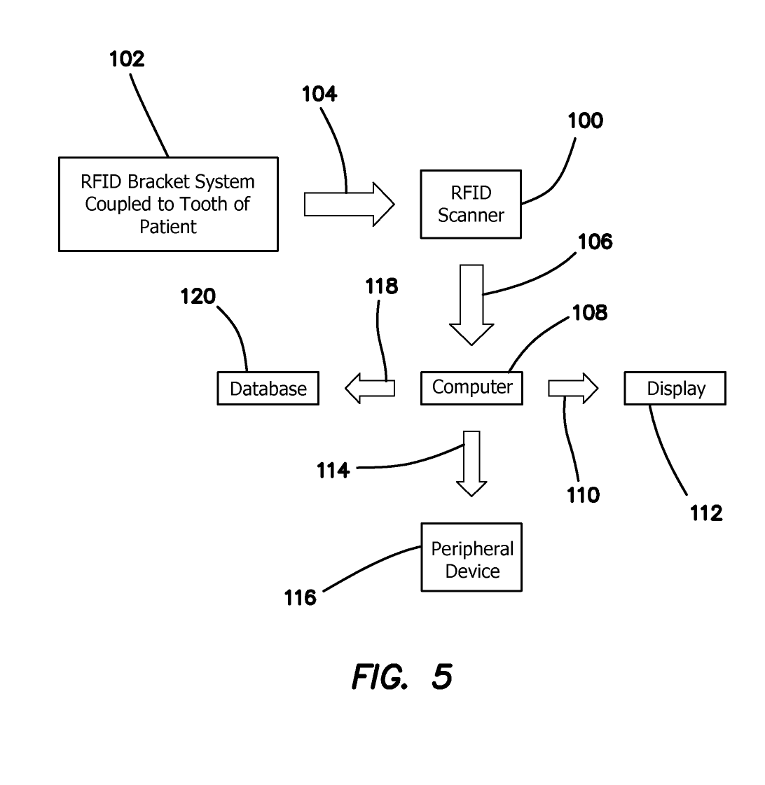

In one embodiment shown in the block diagram of FIG. 5, the RFID scanner 100 reads the location and type information stored in the RFID bracket system 102 coupled to the tooth or teeth of a patient via step 104. It is to be expressly understood that the RFID scanner 100 may read the information off a RFID bracket system 102 that comprises a single bracket and RFID microchip, or off a plurality of RFID microchips and brackets that constitute a portion or the entirety of the patient's mouth. The RFID scanner 100 then produces a list or chart of the RFID bracket system 102 in place within patients mouth complete with each bracket's location, particular prescription, including wire slot sizes, tips, torques, and material of manufacture and then transmits that list or chart to a computer 108 at step 106.

A user at computer 108 may then take the RFID bracket system 102 information sent by the RFID scanner 100 and store it to an internal database 120 via step 118. Alternatively, the user may also display the acquired information on a display 112 coupled to the computer 108 at step 110, or send the information out to a peripheral device 116 at step 114. The peripheral device 116 may comprise any one or combination of a plurality of devices including three dimensional printers, paper printers, copiers, web servers, or other networked computers. Additionally, the peripheral device may include an external memory device such as a FLASH drive or compact disc.

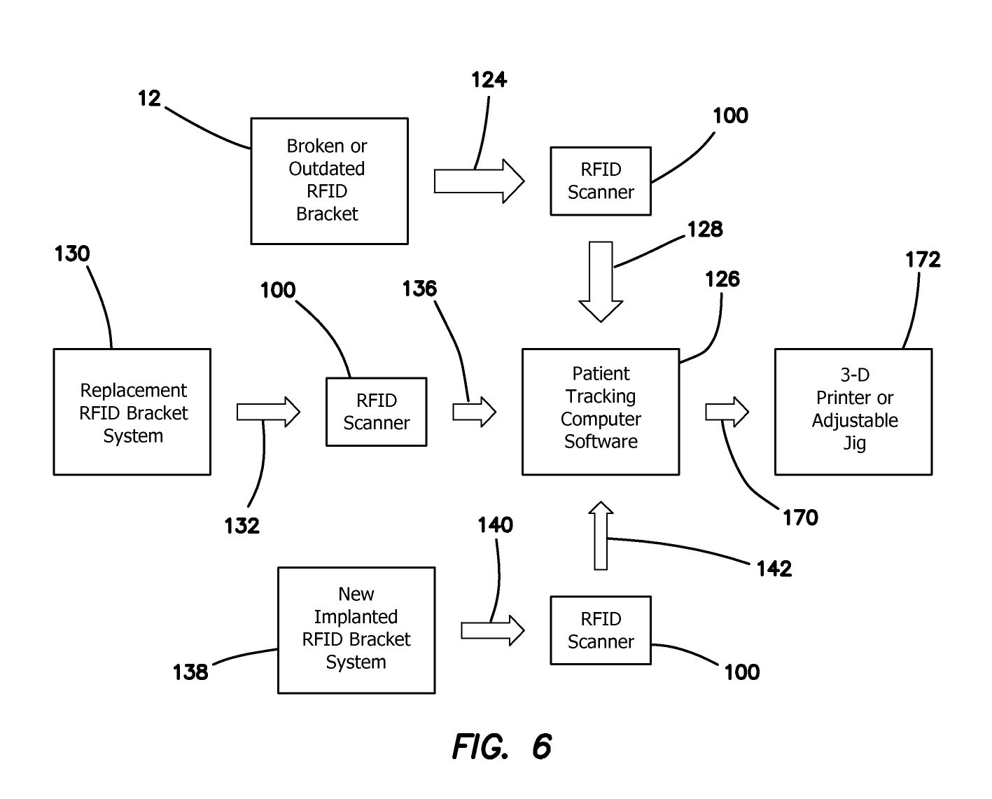

If the bracket 12 becomes dislodged, broken or lost so that a replacement is required, the method of the illustrated embodiment in the block diagram of FIG. 6 scans the dislodged, broken or lost RFID bracket 12 with the RFID scanner 100 at step 124. The location information for the dislodged, broken or lost bracket 12 is read from the RFID chip, if available, or downloaded from a database where it was previously stored. Prior to replacing the old bracket, a replacement RFID bracket system 130 is scanned by an RFID scanner 100 at step 132 to be sure in fact that the new bracket being implanted is the proper bracket with the proper prescription. Information scanned off of the new bracket 130 is turn uploaded to the patient tracking computer software 126 via step 136.

At this point a new tray or jig is needed to precisely place the replacement bracket 12. The stored data for an orthodontic tray or jig for the tooth in question is retrieved from the patient tracking computer software 126 and a set of machine instructions generated and communicated at step 170 to a three dimensional printer which manufactures a new tray or jig for the needed bracket or a set of parameters to be displayed by which an adjustable jig for the bracket 12 can be manually or machine adjusted. In either case, the replacement bracket 12 is mounted into the newly manufactured or adjustable jig and used by the practitioner to precisely position the new bracket 12 onto the tooth.

Once the brackets are placed through direct or indirect placement, the orthodontist scans the entire newly placed RFID bracket system 138 with the RFID scanner 100 at step 140. The information received from the newly placed RFID bracket system 138 is then sent into the patient tracking computer software program 126 at step 142. The patient tracking computer software 126 is integrated with a practice management program (not shown) and is attached to the patient's individual tooth chart within the computer 108. The tooth chart therefore represents the entirety of the patient's treatment from start to finish and shows what RFID bracket system was scanned at each step along the way which assures a high degree of accuracy and efficiency. The scanned data is then resident in the patient's electronic chart and available for quick access.

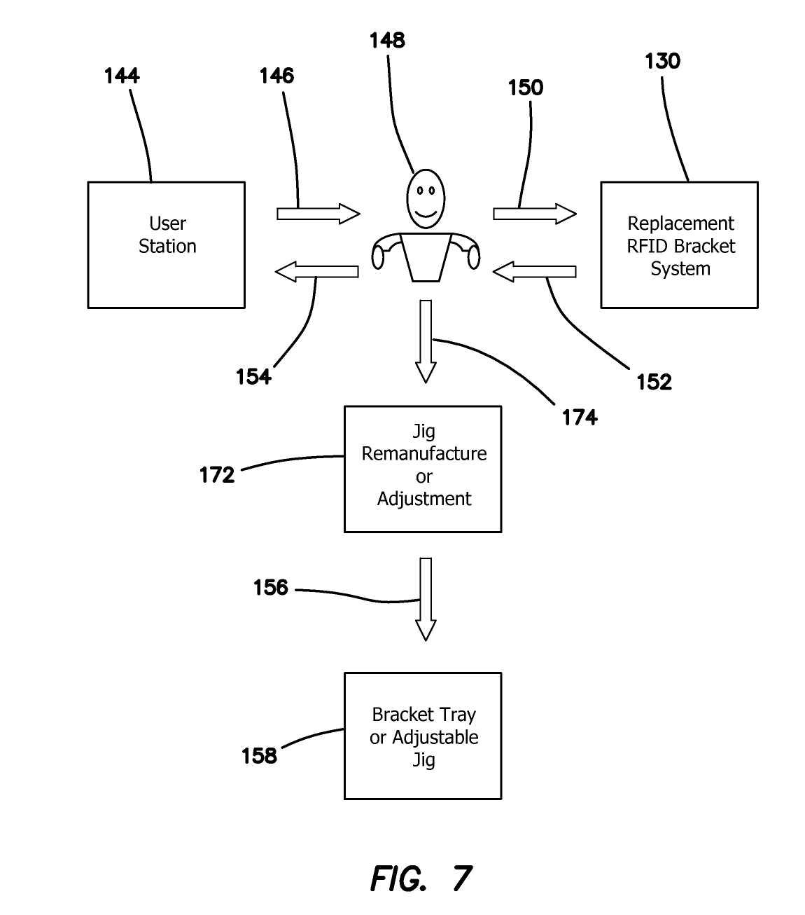

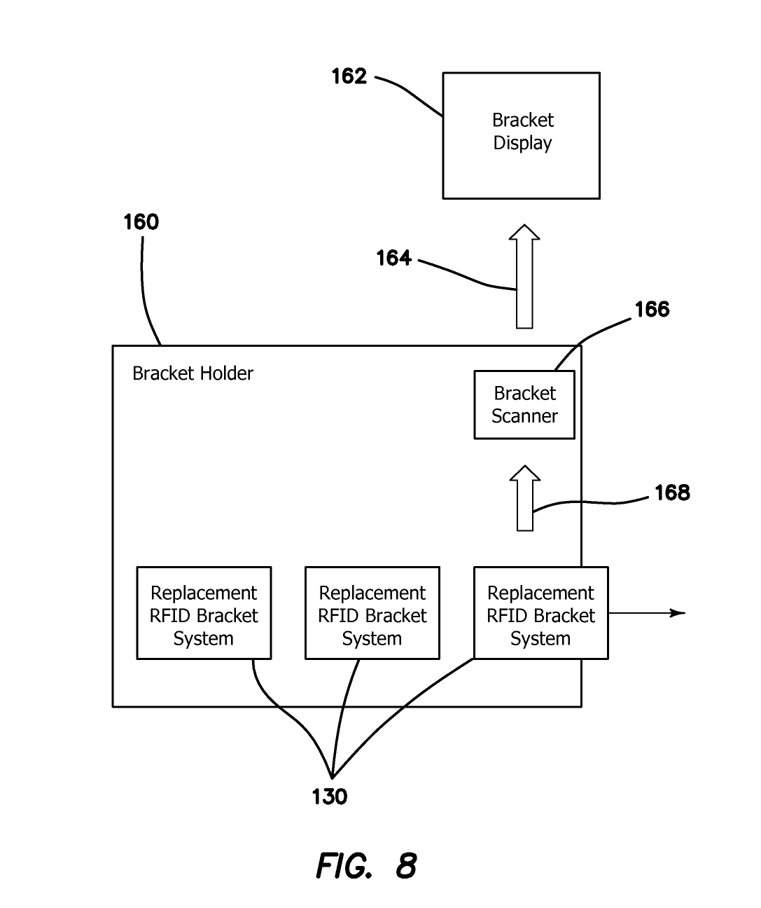

In another embodiment depicted in FIG. 7, the RFID chip and scanner is used in a robotic system of bracket placement for preparation of indirect or direct bonding trays or jigs. A user at a user station 144 enters into the user station 144, which for example may be a networked computer or a software program module within a computer, the corresponding information for a particular dislodged, broken or lost RFID bracket 12 inventoried in bracket system 130. The user station 144 sends the entered location and type data to a robot 148 at step 146. The robot 148 moves to where the replacement RFID bracket system 130 is located at step 150 and reads the information of the RFID chip 10 at step 152. The robot 148 and then verifies and documents the choice with the user station 144 at step 154. Alternatively, step 152 comprises the step of the robot 148 physically removing the replacement RFID bracket 12 from bracket system 130. The robot 148 then retrieves the location and type data and generates the machine instructions to a three dimensional printer 172 to make a replacement tray, or jig or to make adjustments to an adjustable jig 172 at step 174. In addition, printer 172 may manufacture the bracket itself and jig the together so that the bracket/jig assembly is ready to use for placement onto the precisely intended position on the tooth without the need to separately align or place the bracket into the jig. Robot 148 then installs or deposits the replacement RFID bracket 12 into the new bracket tray 158 or adjustable jig 158 at step 156.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

For example, the RFID microchip 10 may be coupled to one or multiple locations on the bracket 12 other than those specified above and shown in the figures.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. A method of remanufacturing a jig for an orthodontic bracket corresponding to a tooth comprising:
scanning recorded bracket tooth shape, bracket type and location data from a radio frequency identification (RFID) microchip in or on the bracket for the tooth at a treatment site, where the RFID microchip has recorded therein bracket tooth shape, bracket type and location data of the intended precise position of the bracket on the corresponding tooth, or in the absence of the RFID microchip downloading the tooth shape, bracket type and location data for the tooth from a database;
providing the tooth shape, bracket type and location data to a three dimensional printer; and
manufacturing a jig at the treatment site using the three dimensional printer to provide a jig which precisely fits the tooth and which carries the correct type bracket for precise placement of the bracket onto the tooth.

2. The method of claim 1 further comprising simultaneously manufacturing the bracket with the jig with the bracket in place in the jig.

3. The method of claim 1 further comprising using the tooth shape, bracket type and location data to select the bracket from an inventory of brackets.

4. The method of claim 1 further comprising replacing the orthodontic bracket when a change in prescription is needed comprising:
scanning the orthodontic bracket being replaced prior to removal;
replacing a current set of patient information with an updated set of scanned information; and
documenting in a patient tooth chart correlated to the updated set of scanned information a reason the at least one orthodontic bracket is being replaced.

5. The method of claim 4 further comprising scanning a replacement bracket to insure that the replacement bracket has a proper prescription.

6. The method of claim 1 where scanning recorded bracket tooth shape, bracket type and location data from the RFID microchip coupled to the bracket further comprises:
sending the bracket type data to a robotic system;
the robotic system selecting a bracket based on the bracket type data;
the robotic system scanning the selected bracket;
the robotic system confirming that the selected bracket has the bracket type data;
the robotic system recording that the selected bracket has been confirmed with having the bracket type data;
the robotic system providing the tooth shape, and location data to a three dimensional printer so that the jig is manufactured at the treatment site using the three dimensional printer to provide a jig which precisely fits the tooth and which carries the correct type bracket for precise placement of the bracket onto the tooth; and
the robotic system setting the selected bracket into the remanufactured jig.

7. A method of using radio frequency identification (RFID) microchips in orthodontic brackets comprising:
providing a plurality of RFID microchips coupled to, on or in a corresponding plurality of orthodontic brackets, at least one RFID microchip for each tooth, where the plurality of RFID chips have recorded therein information concerning a set of features of each one of the corresponding ones of the plurality of orthodontic brackets;
scanning the recorded information from the plurality of RFID chips coupled to the plurality of orthodontic brackets; and
employing the plurality of orthodontic brackets according to the recorded information scanned out of the corresponding plurality of RFID chips by using the plurality of RFID chips to give scanned information to a software program which uses the scanned recorded information to manufacture at the treatment site a jig for carrying the brackets or at least one bracket.

8. The method of claim 7 further comprising using the scanned recorded information to manufacture at the treatment site a jig for carrying the brackets or at least one bracket, and to simultaneously manufacture at the treatment site the brackets or at least one bracket.

9. The method of claim 7 further comprising employing the plurality of orthodontic brackets according to the recorded information scanned out of the corresponding plurality of RFID chips by using the plurality of RFID chips to give scanned information to a software program which uses the scanned recorded information to bend custom wires or plan treatment with specialized orthodontic programs.

10. The method of claim 7 wherein employing the plurality of orthodontic brackets according to the recorded information scanned from the corresponding plurality of RFID chips comprises using the information for determining an inventory of the plurality of orthodontic brackets.

11. The method of claim 7 wherein employing the plurality of orthodontic brackets according to the recorded information scanned from the corresponding plurality of RFID chips comprises identifying a type for each of the plurality of orthodontic brackets to a user.

12. The method of claim 11 where identifying the types for each of the plurality of orthodontic brackets to the user comprises identifying a prescription of the corresponding plurality of orthodontic brackets including but not limited to at least one torque applied to the plurality of orthodontic brackets or at least one tip machined into a bracket slot for each corresponding tooth.

13. The method of claim 7 where employing the plurality of orthodontic brackets according to the recorded information scanned from the corresponding plurality of RFID chip comprises: identifying the plurality of orthodontic brackets in an area of the mouth; or identifying the plurality of orthodontic brackets in the entire mouth in order to produce a patient tooth chart of a location, prescription, including wire slot size, tip structure, torque applied to the bracket, and/or material of manufacture of each of the plurality of orthodontic brackets.

14. The method of claim 7 further comprising replacing a plurality of orthodontic brackets when a change in prescription is needed comprising:
scanning the plurality of orthodontic brackets being replaced prior to removal;
replacing a set of current patient information with an updated set of scanned information; and
documenting a reason the plurality of orthodontic brackets are being replaced in a patient tooth chart correlated to the scanned recorded identification.

15. The method of claim 14 further comprising scanning a plurality of replacement brackets to insure that the plurality of replacement brackets have a proper corresponding prescription.

16. The method of claim 13 where identifying the plurality of orthodontic brackets in an area of the mouth or identifying the plurality of orthodontic brackets in the entire mouth further comprises integrating the identification of the plurality of orthodontic brackets with a practice management program and attaching the practice management program to a patient tooth chart.

17. An apparatus comprising:
a radio frequency identification (RFID) microchip;
an orthodontic bracket;
the RFID microchip coupled to, in or on the orthodontic bracket, where the RFID microchip has recorded thereon information concerning tooth shape, bracket type and location data of the orthodontic bracket;
a scanner for scanning the recorded information from the RFID microchip coupled to the orthodontic bracket; and
a three dimensional printer communicated to the scanner for receiving the recorded information to manufacture on site a jig for use in indirect bonding of the bracket to the tooth.

18. An apparatus comprising:
a computer for storing information concerning tooth shape, bracket type and location data of an orthodontic bracket; and
a three dimensional printer communicated to the computer for receiving the recorded information to manufacture on site a jig and/or bracket for use in indirect bonding of the bracket to the tooth.

19. The apparatus of claim 18 where the three dimensional printer communicated to the computer simultaneously manufactures on site a jig and the bracket in the jig for use in indirect bonding of the bracket to the tooth.
